(19) United States
(12) Patent Application Publication
(10) Pub. No.: US 2026/0254331 A1
(43) Pub. Date: Aug. 27, 2026

(54) METHOD FOR POSITIONING A ROTOR SHAFT OF AN ELECTRIC MOTOR, COMPUTER PROGRAM, COMPUTER PROGRAM PRODUCT, SYSTEM, AND VEHICLE

(71) Applicant: Schaeffler Technologies AG & Co. KG, Herzogenaurach (DE)

(72) Inventors: Soufiane KOLODZIEJ, Regenstauf (DE); Peter SENFT, Rieden (DE); Christian MEY, Maxhütte Haidhof (DE); Markus STRÖHLA, Wenzenbach (DE)

(21) Appl. No.: 19/471,523

(22) PCT Filed: Mar. 25, 2024
(86) PCT No.: PCT/EP2024/057982

§ 371 Date: Oct. 1, 2025

(30) Foreign Application Priority Data
Apr. 5, 2023 (DE) 10 2023 203 149.3

(51) Int. Cl. H02K 15/144

(52) U.S. Cl. CPC H02K 15/144

(57) ABSTRACT

A method for positioning an electric motor rotor shaft includes determining the initial position of the rotor shaft from rotational angle positions of the rotor shaft in which the rotor shaft (RW) can be locked or unlocked by a form-fitting element of a locking actuator. To determine an initial position, the rotor shaft is divided into sections over the circumference of the rotor shaft such that one form-fitting element section is paired with each of the sections, the form-fitting element section joinable to a complementarily shaped form-fitting element section of the locking actuator. The rotor shaft is positioned in one of the rotational angle positions, the absolute rotational angle position of the rotor shaft detected by a rotor position sensor, and locking or unlocking the rotor shaft in the rotational angle position in that the form-fitting element is moved into or out of the rotor shaft in a stroke movement.

### CROSS REFERENCE TO RELATED APPLICATIONS

This is a U.S. national stage of Application No. PCT/EP2024/057982 filed Mar. 25, 2024. Priority is claimed on German Patent Application No. DE 10 2023 203 149.3 filed Apr. 5, 2023, the contents of which are incorporated herein by reference.

### BACKGROUND OF THE INVENTION

### 1. Field of the Invention

The disclosure relates to a method for positioning a rotor shaft of an electric motor, in particular for driving a vehicle.

The disclosure also relates to a computer program and a computer program product, each of which reproduces this method, a system with a locking actuator and a control unit connected to the locking actuator, wherein the control unit has such a computer program or computer program product, and a vehicle with such a computer program or computer program product.

### 2. Description of the Related Art

Parking locks in which an electrically actuatable lever having what is known as a pawl tooth interacts with a gearwheel of a drivetrain in order to block or to lock the drivetrain are known. Mention will be made for example of document DE 10 2017 102 804 A1, which describes such a parking lock having a pawl mechanism.

Parking locks having a locking member or locking element that is able to be adjusted or moved in a straight line along a movement path are also known. Mention will be made for example of document DE 10 2019 110 384 A1, which describes such a parking lock comprising a locking bolt.

### SUMMARY OF THE INVENTION

An object of one aspect of the present invention is to improve both the locking and unlocking of such a parking lock.

A method is proposed for positioning a rotor shaft of an electric motor, in particular for driving a vehicle, comprising the following:
determining the initial position of the rotor shaft from a plurality of definable rotational angle positions of the rotor shaft in which the rotor shaft can be locked or unlocked without restriction by a form-fitting element of a locking actuator,
   wherein to determine said initial position, the rotor shaft is divided into individual circular segment sections over the circumference of the rotor shaft such that one form-fitting element section is paired with each of the circular segment sections, said form-fitting element section being capable of being joined to a complementarily shaped form-fitting element section of the locking actuator,
positioning the rotor shaft in one of the rotational angle positions, the absolute rotational angle position of the rotor shaft being detected by a rotor (shaft) position sensor, and
locking or unlocking the rotor shaft in said rotational angle position in that the form-fitting element is moved into or out of the rotor shaft in a stroke movement.

What is referred to as a rotor (shaft) position sensor may be used to precisely determine a position or pose of a rotor of the electric motor and thus a position or pose of said rotor shaft on which the rotor is arranged relative to the three phases or to the poles of a stator of the electric motor. The rotor (shaft) position sensor thus enables, on the one hand, efficient commutation of the electric motor and, on the other hand, provision of an absolute rotational angle position of the rotor shaft.

The rotor (shaft) position sensor may in this case be designed in the form of an inductive signal transmitter or in the form of a Hall transmitter, the operation of which is known sufficiently to a person skilled in the art. The rotor (shaft) position sensor may be provided on the electric motor side or on the vehicle drive side, i.e., on a traction drive of a vehicle in the form of an electric motor, or on the locking actuator side, i.e., on the locking actuator.

The initial position of the rotor shaft is understood to be an ideal rotational angle position or ideal position of the rotor shaft relative to the form-fitting element of the locking actuator, namely from a plurality of definable, ideal rotational angle positions or ideal positions of the rotor shaft, in which the rotor shaft is positioned or aligned relative to the form-fitting element in such a way that the rotor shaft can be locked or unlocked without restriction by the form-fitting element of the locking actuator.

The term “without restriction” means that the two form-fitting element sections interacting with each other do not come into contact with each other in terms of their associated flanks in the circumferential direction of the rotor shaft or the locking actuator, or rather that they engage with each other without contact or are in a contact-free position relative to each other.

Starting from this initial position, once it has been determined, the rotor shaft can be rotated or moved into the respective ideal positions in accordance with the aforementioned definable division of the rotor shaft over its circumference into the aforementioned circular segment sections, taking into account its current, precisely recorded rotational angle position. These so-called ideal positions represent support points which are stored in software or a computer program of a control unit for controlling or rotating the rotor shaft.

The proposed method therefore enables the rotor shaft to be locked or unlocked without restriction by the aforementioned form-fitting element of the locking actuator, because the two interlocking elements that interact with each other are positioned or aligned with each other for the purpose of locking or unlocking the rotor shaft in such a way that there is no contact between their flanks in the circumferential direction of the rotor shaft or the locking actuator. A form fit between the two form-fitting element sections is thus established without contact with regard to these flanks, or it is released without contact with regard to these flanks. This means that, from the point of view of the locking actuator, locking or unlocking can be performed in a force-optimized manner, i.e., with minimal force.

This force-optimized actuation of the locking actuator in turn makes it possible to design the locking actuator to be as small and compact as possible and at the same time sufficiently robust, i.e., cost-effective and weight-saving. This is also accompanied by simplification of installation effort for such a locking actuator.

It is proposed that ideal rotational angle positions be used in which the two interlocking form-fitting element sections do not form a relative angle to each other or with each other. This means that the two form-fitting element sections are centered relative to each other in the circumferential direction of the rotor shaft or the locking actuator.

Alternatively, rotational angle positions in the sense of ideal positions can also be used in which the two cooperating form-fitting element sections form a relative angle to each other or with each other, so that they form an off-centre arrangement relative to each other in the circumferential direction of the rotor shaft or the locking actuator, provided that no contact is made with regard to the aforementioned flanks of the form-fitting element sections in the circumferential direction of the rotor shaft or the locking actuator. In this case, mechanical play between the two form-fitting element sections would be provided accordingly in the circumferential direction of the rotor shaft or the locking actuator. Depending on the design, such mechanical play allows for a variety of possible positions of the two interlocking elements relative to each other in which the aforementioned contact between the aforementioned flanks does not occur.

It is proposed to use a uniform division to subdivide the circumference of the rotor shaft. This simplifies the positioning of the rotor shaft, starting from the said initial position once it has been determined and fixed.

In one embodiment, a locking mechanism is proposed in which
the form-fitting element is moved in an axial stroke movement and longitudinally to the rotor shaft. A rotor shaft with external toothing in an area of one of its ends and a complementary form-fitting element can be used, which is moved in an axial stroke movement and longitudinally to the rotor shaft against and into the rotor shaft.

The proposed method can be used to safeguard a vehicle. It is proposed that, after the form-fitting element has been moved into the rotor shaft without restriction, the rotor shaft is struck against the form-fitting element in a defined clockwise or anti-clockwise direction in order to brace the rotor shaft against the form-fitting element. The rotor shaft can be struck against the form-fitting element until a definable electric motor deactivation torque is reached, at which point the rotation of the rotor shaft is interrupted.

In this case, the deactivation torque of the electric motor corresponds to a monitorable current consumption of the electric motor, such that when a definable reference value for the current consumption is reached, the electric motor is deactivated or the rotation of the rotor shaft is interrupted.

This deliberately induced bracing provides effective protection against tampering, which prevents or at least significantly hinders the unlocking of the locking actuator by third parties or unauthorized persons. In the event of an attempt to manipulate the locking actuator in the clamped state of the locking mechanism, for example by applying a current to the actuator, the force generated by the actuator is insufficient for the unlocking operation.

The proposed method can also be used to release a rotor shaft that is stressed and clamped against the form-fitting element due to load. In this case, the rotor shaft is positioned in the rotational angle position in which it was previously locked without restriction in order to relax the rotor shaft, whereupon the form-fitting element is subsequently moved out of the rotor shaft without restriction.

Such a load-induced braced state of a rotor shaft occurs, for example, when a vehicle is parked at an angle, for example due to a kerb on which it is parked with only one tyre resting on it. In this case, when the locking actuator is locked, the drive train becomes stressed because the vehicle is supported by the locking actuator. In such a state of the vehicle, a greater unlocking force to be applied by the locking actuator is required to unlock the locking actuator, compared to a flat parking position of the vehicle.

Consideration may also be given at this juncture for example to a parking situation in which a vehicle is parked on a road with an incline or gradient. In a situation such as this as well, the vehicle is supported by the parking lock, namely on account of a downhill slope force that acts on the vehicle and, as such, attempts to move the vehicle.

Also proposed are a computer program for performing the method described above and a computer program product comprising program code stored on a computer-readable data carrier in order to perform the method described above when the program code is executed on a computer.

Furthermore, a system with a locking actuator and a control unit connected to the locking actuator is proposed, wherein the control unit has a computer program or a computer program product of the type described above, as well as a vehicle with a computer program or a computer program product of the type described above.

In this case, a vehicle should be understood to mean any type of vehicle or motor vehicle that is operated by way of electric motor, but in particular passenger cars and/or utility vehicles in the form of electric or hybrid vehicles. These may be semi-autonomous or fully autonomous vehicles.

### BRIEF DESCRIPTION OF THE DRAWINGS

The partially schematic figures show:

FIG. 1 is an arrangement of a locking actuator and a lockable rotor shaft of an electric motor,

FIG. 2 is a systemic representation of an inverter with a control unit and the locking actuator shown in FIG. 1 with a control unit,

FIG. 3 is a locking process of the locking mechanism shown in FIG. 1, and

FIG. 4 an unlocking process of the locking mechanism shown in FIG. 1.

### DETAILED DESCRIPTION OF THE PRESENTLY PREFERRED EMBODIMENTS

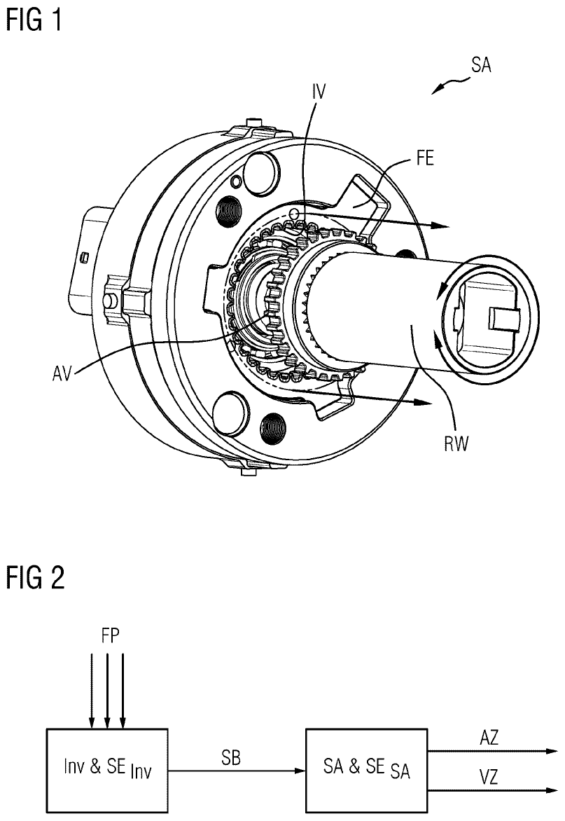

The locking mechanism according to FIG. 1 illustrates two form-fitting elements that are designed to be complementary to each other and can be rotated relative to each other, namely a first form-fitting element FE of a locking actuator SA and a second form-fitting element in the form of a lockable rotor shaft RW of an electric motor (not shown) for driving a vehicle. The locking actuator SA is attached to a housing (not shown) of the electric motor of an electric motor drive unit, which may comprise a transmission, and can therefore be supported by this housing. Depending on the state of the locking mechanism, these two form-fitting elements FE, RW are arranged coaxially (unlocked state) or concentrically in sections (locked state) relative to each other.

An internal toothing IV of the form-fitting element FE interacts with an external toothing AV of the rotor shaft RW, which is formed as such in a region of one end of the rotor shaft RW, in that the form-fitting element FE is electrically actuated in an axial stroke movement and longitudinally to the rotor shaft RW and is thereby joined to the rotor shaft end in sections.

The vehicle, which comprises this locking mechanism, comprises an electric motor drive unit having an electric motor in the form of a permanently or separately excited synchronous machine for driving the vehicle, wherein the electric motor can possibly be combined with a reduction gear, a high-voltage battery and an inverter which is comprised of power electronics of the vehicle and which establishes the connection between the electric motor and the high-voltage battery. In this case, the power electronics can optionally comprise an integrated voltage converter which supplies power from the high-voltage on-board electrical system of the vehicle to a low-voltage on-board electrical system of the vehicle.

A control unit of the inverter controls, regulates and monitors the electric motor and ensures torque supply and speed control of a drive train of the vehicle according to requirements. Moreover, the inverter converts the DC voltage of the high-voltage battery into the
AC voltage required by the electric motor.

The power electronics or the inverter comprised by the power electronics not only supplies the electric motor with power, but also the high-voltage battery
namely when the electric motor operates as a generator and feeds electricity into the high-voltage battery. In this process, known as recuperation,
   it converts the alternating current generated by the electric motor into direct current and uses it to charge the high-voltage battery.

FIG. 2 illustrates a systemic connection between the inverter in question or an inverter-specific control unit SE_{Inv} and the locking actuator or a locking actuator-specific control unit SE_{SA}. The control unit SE_{Inv} issues a control command SB to the control unit SE_{SA} depending on the input parameters FP of the vehicle (FP=vehicle parameters), whereupon the locking actuator SA locks or unlocks the rotor shaft RW. The control unit SE_{SA} displays or outputs an actuator status AZ and a locking status VZ.

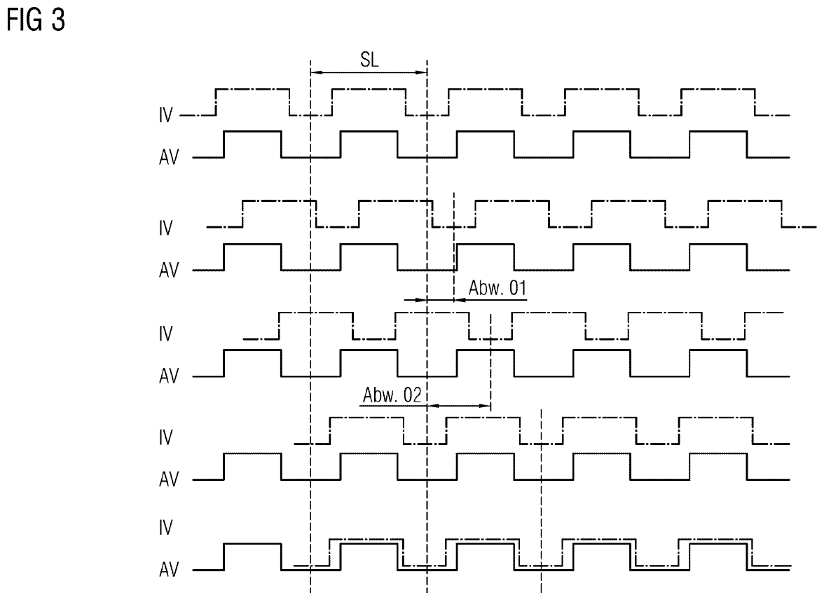

FIG. 3 illustrates a wound-up arrangement of the internal toothing IV of the form-fitting element FE and the external toothing AV of the rotor shaft RW in relation to each other, relative to a circumferential direction and a longitudinal direction of the two form-fitting elements FE, RW. The internal toothing IV is stationary relative to the circumferential direction of the two form-fitting elements FE, RW, and the external toothing AV can be rotated relative to the internal toothing IV.

Both the form-fitting element FE and the rotor shaft RW are divided into uniform circular segments (circular segment=360°/n; n=number of teeth) according to a definable common pitch over the respective circumference, which thus all have the same angular extension.

In the wound representation shown in FIG. 3, this angular extension of such a circular segment section is illustrated as segment length SL. And in relation to a radius from the centre of the form-fitting element FE or from the centre of the rotor shaft RW, this angular extension corresponds to a pitch-related arcuate distance between the centres of two adjacent teeth of the internal toothing IV or the centres of two adjacent tooth gaps of the external toothing AV.

This segment length SL according to FIG. 3—expressed in degrees (angle)—describes a step size from one ideal alignment to the next ideal alignment of the two form-fitting elements FE, RW to each other, whereby in these ideal alignments the respective associated segment lengths SL do not exhibit or enclose any angular offset to each other. This means that these respective associated segment lengths SL coincide exactly with each other and thus do not represent any displacement or deviation from each other in the circumferential direction of the two form-fitting elements FE, RW.

Such an ideal alignment of the two form-fitting elements FE, RW relative to each other is illustrated by the uppermost arrangement of the internal toothing IV and the external toothing AV shown in FIG. 3. In this arrangement, the two form-fitting elements FE, RW are not joined together. The locking mechanism formed by the two form-fitting elements FE, RW is therefore unlocked or released. One of these ideal alignments in one direction of rotation of the rotor shaft RW must be determined as an initial position or location in which the two form-fitting elements FE, RW can be joined together without contact and thus without restriction with respect to the respective associated tooth flanks and, as a result, in a force-optimized manner from the perspective of the locking actuator SA.

Knowing this once-determined initial position, the rotor shaft RW can be rotated into the respective ideal alignments or the corresponding rotational angle positions according to the specified pitch, i.e., the number of circular segment sections, which is defined by the number of teeth (illustrated by the penultimate arrangement in FIG. 3). An absolute rotational angle position of the rotor shaft RW is precisely recorded by a rotor (shaft) position sensor.

In this way, the circumferences of the two form-fitting elements FE, RW can be divided into, for example, n=32 (because each has 32 teeth) circular segment sections, resulting in uniform circular segment sections of 360°/32=11.25°. The aforementioned ideal alignments or the corresponding rotational angle positions of the rotor shaft RW thus represent support points which are stored as such in the control unit SE_{Inv} and can be approached.

The second and third arrangements of the internal toothing IV and the external toothing AV shown in FIG. 3 each illustrate a deviation Abw. 01, Abw. 02 between the assigned segment lengths SL, wherein these deviations Abw. 01, Abw. 02 do not allow a form fit of the locking mechanism.

In a parking situation in which the vehicle is to be brought to a standstill and locked, the rotor shaft RW can be rotated in a first or in a second direction of rotation opposite to this, i.e., clockwise or anticlockwise, into one of the said ideal alignments.

The rotor shaft RW can be rotated—taking the shortest route—into the nearest ideal alignment or to the nearest support point, i.e., to the ideal alignment that forms the smallest angle or the smallest angle difference with the currently detected absolute rotational angle position of the rotor shaft RW, provided that the environmental conditions permit this. The rotor shaft RW is therefore rotated by one of these detected angular differences to the corresponding support point.

In the penultimate arrangement shown in FIG. 3, which illustrates such an ideal alignment of the rotor shaft RW with the form-fitting element FE, the control unit SE_{Inv} of the inverter issues the control command SB to the control unit SE_{A} of the locking actuator SA, whereupon the form-fitting element FE—while the vehicle is stationary (vehicle speed=0 km/h)—is actuated or moved eclectically against the rotor shaft RW. In this process, the form-fitting element FE is moved into the rotor shaft RW without restriction, i.e., without contact with the respective tooth flanks and, as a result, in a force-optimized manner from the perspective of the locking actuator SA.

The last or bottom arrangement in FIG. 3 illustrates a form fit of the locking mechanism. The two form-fitting elements FE, RW are slightly offset from each other due to play. This means that the associated circular segment sections of the two form-fitting elements FE, RW are no longer exactly aligned with each other.

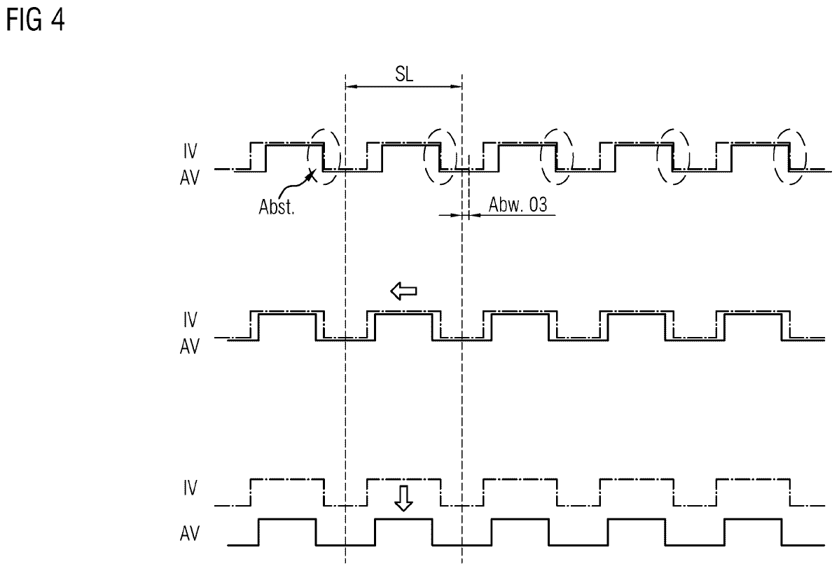

FIG. 4, on the other hand, illustrates the unlocking or release of the locking mechanism starting from the uppermost arrangement shown in FIG. 4, in which a locking state or locked state of the locking mechanism is illustrated. This uppermost arrangement illustrates a state in which the external toothing AV is engaged with the internal toothing IV. In this arrangement, a deviation Abw. 03 between the respective associated segment lengths SL is illustrated.

This may be due to the vehicle being parked on uneven ground, so that the vehicle is supported by the locking actuator SA and thus by the housing of the electric motor due to the inclination. This in turn causes the rotor shaft RW to be braced against the form-fitting element FE.

Such bracing of the rotor shaft RW against the form-fitting element FE can also be caused by the fact that, after being locked without restriction by the form-fitting element FE, the rotor shaft RW is struck in a defined manner in a clockwise or anti-clockwise direction against the form-fitting element FE in order to brace the rotor shaft RW against the form-fitting element FE in a defined manner. This ensures protection against manipulation by third parties or unauthorized persons, which prevents or at least significantly hinders the unlocking of the locking actuator.

When the vehicle is started up, the control unit SE_{A} displays a locking status VZ and outputs it to the control unit SE_{Inv}. The control unit SE_{Inv} outputs a control command SB to the control unit SE_{A} to unlock the rotor shaft RW. The rotor shaft RW is then positioned—with the vehicle stationary (vehicle speed=0 km/h) and with knowledge of the precisely recorded absolute position or position of the rotor shaft RW—it is positioned in the rotational angle position in which it was previously locked and with which the currently detected absolute rotational angle position of the rotor shaft RW forms an angle or an angle difference in order to release the rotor shaft RW. The rotor shaft RW is therefore rotated by this angular difference to the last support point approached.

Subsequently, the form-fitting element FE is moved out of the rotor shaft RW without restriction, i.e., without contact with the respective associated tooth flanks and, as a result, in a force-optimized manner from the perspective of the locking actuator SA, so that the form fit of the locking mechanism is released. The vehicle can then be moved.

The deviation Abw. 03 according to FIG. 4 is not only due to play, i.e., not only due to mechanical play between the form-fitting element FE and the rotor shaft RW in the circumferential direction of the locking actuator SA, but also
by an elasticity underlying the locking mechanism, which causes the rotor shaft RW to move into a corresponding position relative to the form-fitting element FE as a result of a load acting on the locking mechanism. This elasticity depends on the design of the two form-fitting elements FE and RW.

However, such a deviation Abw. 03, in which the rotor shaft RW is braced against the form-fitting element FE, can also be caused solely by an elasticity underlying the locking mechanism, wherein the deviation Abw. 03 in conjunction with an adjusting or representing load, which acts as such on the locking mechanism. This depends on how the two form-fitting elements FE, RW, which interact with each other, are shaped or designed in sections. At this point, mention should be made of a gear pairing in the form of a Hirth gear, which as such does not allow any mechanical play.

The rotor shaft RW can be positioned via a so-called speed control or a so-called torque control with a so-called P component and a so-called I component.

The aforementioned ideal alignments of the two form-fitting elements FE, RW with respect to each other and the corresponding rotational angle positions of the rotor shaft RW, which, as described above, represent support points and are stored in the control unit SE_{Inv}, can also be taught by a learning or adaptation process, so that manufacturing tolerances between the two form-fitting elements FE, RW can be advantageously compensated.

In this case, the control units SE_{Inv}, SE_{A} previously described comprise a digital microprocessor unit (CPU) connected to a storage system and to a bus system for data transfer purposes, a random-access memory (RAM) and a storage. In this case, the CPU is designed to process commands that are implemented as a program stored in a storage system, to acquire input signals from the data bus and to emit output signals to the data bus. The storage system may have various storage media in the form of magnetic, solid-state and other non-volatile media on which a corresponding computer program for performing the method and the advantageous embodiments is stored. The program may be designed such that it embodies or is capable of carrying out the method aspects described here such that the CPU is able to execute the steps of such methods and thus control both the vehicle and the parking lock or locking device.

A computer program having program code for performing all of the steps of any of the claims or method claims when the program is executed in the CPU is suitable for performing the proposed method.

In this case, the computer program may be read into pre-existing actuation electronics simply and used to control both the vehicle and the locking actuator, or the parking lock or locking device.

Provision is made for this purpose for a computer program product having program code stored on a computer-readable data carrier in order to perform the method according to any of the claims when the computer program product is executed in the CPU. The computer program product may also be integrated into the actuation electronics as a retrofitted option.

Although exemplary embodiments are explained in the above description, it is pointed out that numerous modifications are possible. Furthermore, it is pointed out that the exemplary embodiments are only examples that are in no way intended to limit the scope of protection, the applications and the structure. Instead, the above description gives a person skilled in the art a guideline for implementing at least one exemplary embodiment, it being possible to make various changes, especially with regard to the function and arrangement of the component parts described, without departing from the scope of protection as will become apparent from the claims and combinations of features that are equivalent thereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for positioning a rotor shaft of an electric motor, for driving a vehicle, comprising:
determining an initial position of the rotor shaft from a plurality of definable rotational angle positions of the rotor shaft in which the rotor shaft can be locked or unlocked without restriction by a form-fitting element of a locking actuator;
wherein to determine the initial position, the rotor shaft is divided into individual circular segment sections over a circumference of the rotor shaft such that one form-fitting element section is paired with each of the circular segment sections, the form-fitting element section configured to be joined to a complementarily shaped form-fitting element section of the locking actuator;
positioning the rotor shaft in one of the rotational angle positions, an absolute rotational angle position of the rotor shaft being detected by a rotor (shaft) position sensor, and
locking or unlocking the rotor shaft in the rotational angle position in that the form-fitting element is moved into or out of the rotor shaft in a stroke movement.

12. The method as claimed in claim 11, wherein respective rotational angle positions are used in which two form-fitting element sections do not form a relative angle with each other.

13. The method as claimed in claim 11, wherein uniform division is used to subdivide the circumference of the rotor shaft.

14. The method as claimed in claim 11, wherein the form-fitting element is moved in an axial stroke movement and longitudinally to the rotor shaft.

15. The method as claimed in claim 11, wherein the rotor shaft, after the form-fitting element has been moved into the rotor shaft without restriction, is struck in a defined manner clockwise or anticlockwise against the form-fitting element to brace the rotor shaft against the form-fitting element.

16. The method as claimed in claim 11, wherein a rotor shaft that is struck and braced against the form-fitting element due to a load is positioned in the rotational angle position in which it was previously locked without restriction in order to release the rotor shaft, and wherein the form-fitting element is then moved out of the rotor shaft without restriction.

17. A computer program stored on a nontransient computer readable media when the program code is executed on a computer configured to carry out a method for positioning a rotor shaft of an electric motor when the program code is executed on a computer, the method comprising:
determining an initial position of a rotor shaft from a plurality of definable rotational angle positions of the rotor shaft in which the rotor shaft can be locked or unlocked without restriction by a form-fitting element of the locking actuator;
wherein to determine the initial position, the rotor shaft is divided into individual circular segment sections over a circumference of the rotor shaft such that one form-fitting element section is paired with each of the circular segment sections, the form-fitting element section configured to be joined to a complementarily shaped form-fitting element section of the locking actuator;
positioning the rotor shaft in one of the rotational angle positions, an absolute rotational angle position of the rotor shaft being detected by a rotor (shaft) position sensor, and
locking or unlocking the rotor shaft in the rotational angle position in that the form-fitting element is moved into or out of the rotor shaft in a stroke movement.

18. A computer program product, comprising program code stored on a nontransient computer-readable data carrier in order to carry out a method for positioning a rotor shaft of an electric motor when the program code is executed on a computer, the method comprising:
determining an initial position of the rotor shaft from a plurality of definable rotational angle positions of the rotor shaft in which the rotor shaft can be locked or unlocked without restriction by a form-fitting element of a locking actuator;
wherein to determine the initial position, the rotor shaft is divided into individual circular segment sections over a circumference of the rotor shaft such that one form-fitting element section is paired with each of the circular segment sections, the form-fitting element section configured to be joined to a complementarily shaped form-fitting element section of the locking actuator;
positioning the rotor shaft in one of the rotational angle positions, an absolute rotational angle position of the rotor shaft being detected by a rotor (shaft) position sensor, and
locking or unlocking the rotor shaft in the rotational angle position in that the form-fitting element is moved into or out of the rotor shaft in a stroke movement.

19. A system with a locking actuator and a control unit (SE_{Inv}, SE_{SA}) for actuating the locking actuator, wherein the control unit (SE_{Inv}, SE_{SA}) comprises a computer program product configured to:
determine an initial position of a rotor shaft from a plurality of definable rotational angle positions of the rotor shaft in which the rotor shaft can be locked or unlocked without restriction by a form-fitting element of the locking actuator;
wherein to determine the initial position, the rotor shaft is divided into individual circular segment sections over a circumference of the rotor shaft such that one form-fitting element section is paired with each of the circular segment sections, the form-fitting element section configured to be joined to a complementarily shaped form-fitting element section of the locking actuator;
position the rotor shaft in one of the rotational angle positions, an absolute rotational angle position of the rotor shaft being detected by a rotor (shaft) position sensor, and
lock or unlock the rotor shaft in the rotational angle position in that the form-fitting element is moved into or out of the rotor shaft in a stroke movement.

20. A vehicle with a computer program product as claimed in claim 19.
